(19) United States
(12) Patent Application Publication
(10) Pub. No.: US 2014/0246809 A1
(43) Pub. Date: Sep. 4, 2014

(54) SYSTEMS AND METHODS IMPLEMENTING ADDITIVE MANUFACTURING PROCESSES THAT UTILIZE MULTIPLE BUILD HEADS

(71) Applicant: California Institute of Technology, Pasadena, CA (US)

(72) Inventors: Douglas C. Hofmann, Altadena, CA (US); Jean Paul C. Borgonia, Santa Fe Springs, CA (US)

(73) Assignee: California Institute of Technology, Pasadena, CA (US)

(21) Appl. No.: 14/196,628

(22) Filed: Mar. 4, 2014

Related U.S. Application Data
(60) Provisional application No. 61/772,021, filed on Mar. 4, 2013.

(51) Int. Cl. B29C 67/00

(52) U.S. Cl. CPC B29C 67/0088; B29C 67/0051
USPC 264/308; 425/375; 425/174

(57) ABSTRACT

Systems and methods in accordance with embodiments implement additive manufacturing processes that utilize multiple build heads. In one embodiment, an additive manufacturing apparatus includes: a plurality of build heads, each of which being adapted to cause the formation of a structure onto a surface; a substrate; and a translation system, where the translation system is associated with at least one of the plurality of build heads and the substrate, such that the spatial relationship between the plurality of build heads and the substrate can be controlled.

### CROSS-REFERENCE TO RELATED APPLICATIONS

The current application claims priority to U.S. Provisional Application No. 61/772,021, filed Mar. 4, 2013, the disclosure of which is incorporated herein by reference.

### STATEMENT OF FEDERAL FUNDING

The invention described herein was made in the performance of work under a NASA contract, and is subject to the provisions of Public Law 96-517 (35 U.S.C. §202) in which the Contractor has elected to retain title.

### FIELD OF THE INVENTION

The present invention generally relates to additive manufacturing processes incorporating multiple build heads.

### BACKGROUND

‘Additive manufacturing,’ or ‘3D Printing,’ is a term that typically describes a manufacturing process whereby a 3D model of an object to be fabricated is provided to an apparatus (e.g. a 3D printer), which then autonomously fabricates the object by depositing, or otherwise forming, the constituent material in the shape of the object to be fabricated until it is formed. For example, in many instances, successive layers of material that represent cross-sections of the object are deposited or otherwise formed; generally, the deposited layers of material fuse (or otherwise solidify) to form the final object. Because of their relative versatility, additive manufacturing techniques have generated much interest.

### SUMMARY OF THE INVENTION

Systems and methods in accordance with embodiments implement additive manufacturing processes that utilize multiple build heads. In one embodiment, an additive manufacturing apparatus includes: a plurality of build heads, each of which being adapted to cause the formation of a structure onto a surface; a substrate; and a translation system, where the translation system is associated with at least one of the plurality of build heads and the substrate, such that the spatial relationship between the plurality of build heads and the substrate can be controlled.

In another embodiment, the additive manufacturing apparatus further includes a controller for controlling the spatial relationship between the plurality of build heads and the substrate.

In yet another embodiment, the plurality of build heads is configured for functionality in accordance with a direct metal laser sintering additive manufacturing apparatus.

In still another embodiment, at least one of the plurality of build heads is one of: a build head configured for functionality in accordance with a laser engineered net shaping additive manufacturing process and a build head configured for functionality in accordance with an electron beam freeform fabrication additive manufacturing process.

In still yet another embodiment, at least one of the plurality of build heads receives metallic feedstock in the form of one of: powder and wire.

In a further embodiment, at least one of the plurality of build heads heats feedstock using one of: a laser and an electron beam.

In a still further embodiment, at least two of the plurality of the build heads are each sourced with a different feedstock material.

In a yet further embodiment, at least one build head is sourced with a combination of two different feedstock materials.

In a still yet further embodiment, at least two of the plurality of build heads are sourced with feedstock material from a centralized feedstock material source.

In another embodiment, at least two of the plurality of build heads are powered by a single power source.

In yet another embodiment, the power source is laser and the laser is communicated to each of the at least two of the plurality of build heads using at least one of: beam splitters and optics.

In still another embodiment, a method of additively manufacturing a plurality of structures includes: additively manufacturing a first structure using the first of a plurality of build heads; additively manufacturing a second structure using the second of the plurality of build heads; where at least the first of the plurality of build heads and the second of the plurality of build heads are controlled so as to move in unison relative to a substrate during the additive manufacturing of the respective structures.

In still yet another embodiment, at least the first structure and the second structure are additively manufactured onto a surface that is removably disposed onto the substrate.

In a further embodiment, there is at least one moment in time where either the first of the plurality of build heads is causing the formation of structure when the second of the plurality of build heads is not causing the formation of structure or the second of the plurality of build heads is causing the formation of structure when the first of the plurality of build heads is not causing the formation of structure.

In a yet further embodiment, the additive manufacturing of the first structure occurs on a first surface, and the additive manufacturing of the second structure occurs on a second distinct surface, wherein each of the first surface and the second surface are removably disposed on the substrate.

In a still further embodiment, the additive manufacturing of the first structure and the second structure occur on a rotating surface.

In still yet further embodiment, the first structure and the second structure are additively manufactured so that they are identical in shape and are adjoined.

In another embodiment, the first structure is additively manufactured from a first material, and the second structure is additively manufactured from a second, different, material.

In still another embodiment, at least the first structure is additively manufactured from a combination of materials.

In yet another embodiment, an additive manufacturing apparatus includes: a plurality of build heads, each of which being adapted to cause the formation of a structure onto a surface; and a substrate; where each of the plurality of build heads is configured to be able to operate independently from each of the other build heads.

### BRIEF DESCRIPTION OF THE DRAWINGS

FIG. 1 illustrates an additive manufacturing apparatus implementing a plurality of build heads in accordance with embodiments of the invention.

FIG. 2 illustrates a DMLS-type additive manufacturing apparatus implementing a plurality of build heads in accordance with embodiments of the invention.

FIG. 3 illustrates a build head that can be implemented in conjunction with additive manufacturing processes in accordance with embodiments of the invention.

FIG. 4 illustrates an additive manufacturing apparatus implementing an array of build heads in accordance with embodiments of the invention.

FIG. 5 illustrates an additive manufacturing apparatus implementing a plurality of build heads whereby two of the build heads are sourced with different feedstock material in accordance with embodiments of the invention.

FIG. 6 illustrates an additive manufacturing apparatus implementing a plurality of build heads, each of which being sourced by a centralized feedstock source, and each of which operating in conjunction with a single laser source in accordance with embodiments of the invention.

FIG. 7 illustrates a method of efficiently additively manufacturing a plurality of structures in accordance with embodiments of the invention.

FIG. 8 illustrates using an additive manufacturing apparatus that incorporates a plurality of build heads to develop repeating features on an existing part in accordance with embodiments of the invention.

FIG. 9 illustrates using an additive manufacturing apparatus that incorporates a plurality of build heads, whereby each build head can be individually controlled as to whether or not it is causing the formation of structure.

FIG. 10 illustrates using an additive manufacturing apparatus that incorporates a plurality of build heads to develop features onto existing structures in accordance with embodiments of the invention.

FIG. 11 illustrates efficiently additively manufacturing structures onto a rotating work piece in accordance with embodiments of the invention.

FIG. 12 illustrates using an additive manufacturing apparatus that incorporates a plurality of build heads to develop a cellular structure in accordance with embodiments of the invention.

FIG. 13 illustrates an additive manufacturing apparatus where by each of a plurality of build heads is independently operable in accordance with embodiments of the invention.

### DETAILED DESCRIPTION

Turning now to the drawings, systems and methods for implementing additive manufacturing processes that utilize multiple build heads are illustrated. In many embodiments, additive manufacturing apparatuses include a plurality of build heads that are configured to move in unison while additively manufacturing structures. In a number of embodiments, each of at least two of the plurality of build heads is sourced with a different feedstock material. In several embodiments, each of at least two of the plurality of build heads uses the same single power source in causing the formation of a structure. In numerous embodiments, an additive manufacturing apparatus that incorporates a plurality of build heads that move in unison in additively manufacturing structures is used to additively manufacture a cellular structure. In many embodiments, an additive manufacturing apparatus includes a plurality of build heads, each of which can be operated entirely independently of the others.

Additive manufacturing, or ‘3D Printing’, has generated much interest from manufacturing communities because of the seemingly unlimited potential that these fabrication techniques can offer. For example, these techniques have been demonstrated to produce any of a variety of distinct and intricate geometries, with the only input being the final shape of the object to be formed. In many instances, a 3D rendering of an object is provided electronically to a ‘3D Printer’, which then fabricates the object. Many times, a 3D Printer is provided with a CAD File, a 3D Model, or instructions, and the 3D Printer thereby fabricates the object. Importantly, as can be inferred, these processing techniques can be used to avoid heritage manufacturing techniques that can be far more resource intensive and thereby inefficient. While additive manufacturing processes show much promise, current such processes are not without their limitations. For example, additive manufacturing processes are relatively slow; indeed, many geometries can be fabricated more rapidly using conventional machining techniques as opposed to additive manufacturing techniques. As a consequence, additive manufacturing processes have generally been implemented in rapid prototyping applications or else for the fabrication of unique geometries that are not amenable to conventional machining techniques. Nonetheless, it would be advantageous if additive manufacturing processes could be made viable in many other manufacturing scenarios so that their many advantages (e.g., their resource efficiency, that they can enable the fabrication of objects from materials that have been demonstrated to be difficult to machine using conventional machining techniques) could be better harnessed.

Accordingly, in many embodiments, additive manufacturing apparatuses that incorporate a plurality of build heads are used in the fabrication of structures. For instance, in many embodiments, a plurality of build heads of an additive manufacturing apparatus are adjoined to a single translation system, which is itself adjoined to a single controller, such that each of the plurality of build heads can move in unison with movement of the translation system. In essence, the configuration is such that the additive manufacturing caused by a single build head can be mirrored by the remaining build heads. In this way, the plurality of build heads can, for example, simultaneously additively manufacture a plurality of similarly-shaped structures (e.g. since they each traverse a same path). Thus, for example, such additive manufacturing processes can be better adapted for the bulk manufacture of objects. Additive manufacturing apparatuses that incorporate a plurality of build heads are now described in greater detail below.

### Additive Manufacturing Apparatuses Implementing a Plurality of Build Heads

In many embodiments of the invention, an additive manufacturing apparatus incorporates a plurality of build heads that can move in unison and can thereby additively manufacture structures. As is known by one of ordinary skill of the art, additive manufacturing apparatuses generally function by controlling a build head so that it moves in a specific pattern, and incrementally causes the development of a structure to be formed. Whereas conventional additive manufacturing apparatuses typically include a single build head and are thereby typically configured to fabricate a single structure in any given run, additive manufacturing apparatuses that include a plurality of build heads that move in unison can thereby synchronously cause the development of a plurality of similar structures. In general, when an additive manufacturing apparatus that incorporates a plurality of build heads to fabricate a plurality of structures, the effective build time of the structure can be reduced by a factor proportional to the number of build heads that move in unison. In this way, these apparatuses can make additive manufacturing much more viable in the bulk manufacture of structures.

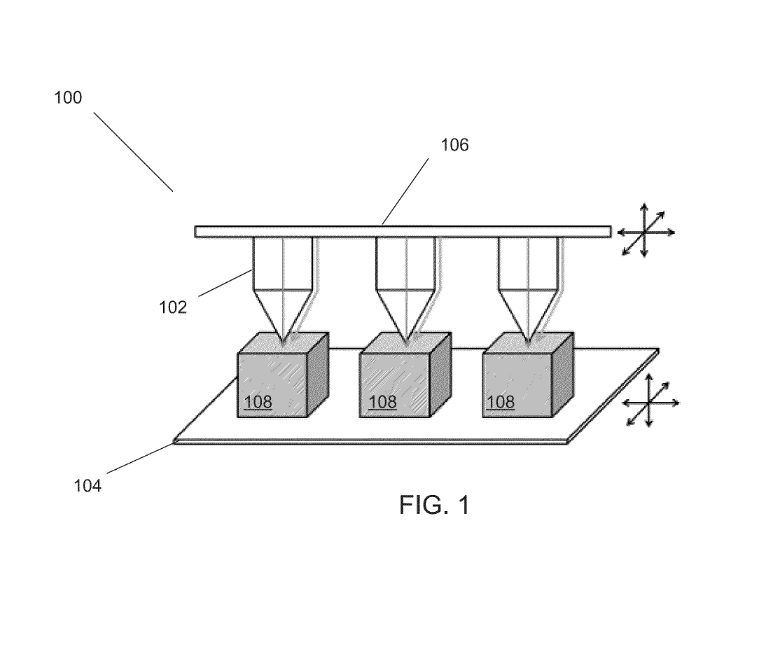

FIG. 1 illustrates an additive manufacturing apparatus that includes a plurality of build heads that are configured to move in unison in accordance with embodiments of the invention. In particular, the additive manufacturing apparatus 100 includes three build heads 102, a substrate 104, and a translation system 106 that is coupled to the plurality of build heads. The translation system 106 may be coupled to a controller (not shown) which governs the motion, e.g. the rastering pattern, of the plurality of build heads 102. Notably, the build heads 102 move in unison with the translation system. The illustration further depicts that the three build heads 102 can cause the formation of three structures 108. In particular, as each of the three build heads 102 move in unison, they can thereby be controlled to cause the development of three similarly-shaped structures 108. In essence, the additive manufacturing ability of a build head is multiplied by the number of incorporated build heads.

Note that FIG. 1 depicts that both the translation system and the substrate are both translatable. Thus, the build heads can be moved relative to the substrate with motion of the translation system, with motion of the substrate, or with a combination of both. In some embodiments, the plurality of build heads is held fixed, and only the substrate is translatable. For example, the substrate can be coupled to a translation system. In a number of embodiments, the plurality of build heads is only allowed to move along one axis, while a substrate is allowed to move along the other two axes. In general, the relative motion between the plurality of build heads and the substrate can facilitate the additive manufacturing process. It should be clear that the plurality of build heads can be moved relative to the substrate in any suitable way in accordance with embodiments of the invention.

Importantly, the above-described architecture can be implemented in conjunction with any of a variety of additive manufacturing apparatuses. In some embodiments, a plurality of build heads is incorporated within an additive manufacturing apparatus adapted for additively manufacturing structures out of plastic materials. In a number of embodiments, a plurality of build heads is incorporated within an additive manufacturing apparatus adapted for additively manufacturing structures out of polymeric materials. In several embodiments, the polymeric materials are cured using techniques such as stereolithography and/or digital light processing during the additive manufacturing process. In numerous embodiments, a plurality of build heads is incorporated within a fused deposition modeling additive manufacturing apparatus. In some embodiments, a plurality of build heads is incorporated within an additive manufacturing apparatus that deposits material in the form of layers, and the layers are ‘laminated’ with one another to thereby form the object to be fabricated. In many embodiments, a plurality of build heads is incorporated within an additive manufacturing apparatus adapted for additively manufacturing structures out of metallic materials. In a number of embodiments, a plurality of build heads is incorporated within one of: a direct metal laser sintering (DMLS) additive manufacturing apparatus; a laser engineered net shaping (LENS) additive manufacturing apparatus; and an electron beam freeform fabrication (EBF³) additive manufacturing process. It should be clear, that the above described principles can be incorporated within any of a variety of additive manufacturing apparatuses.

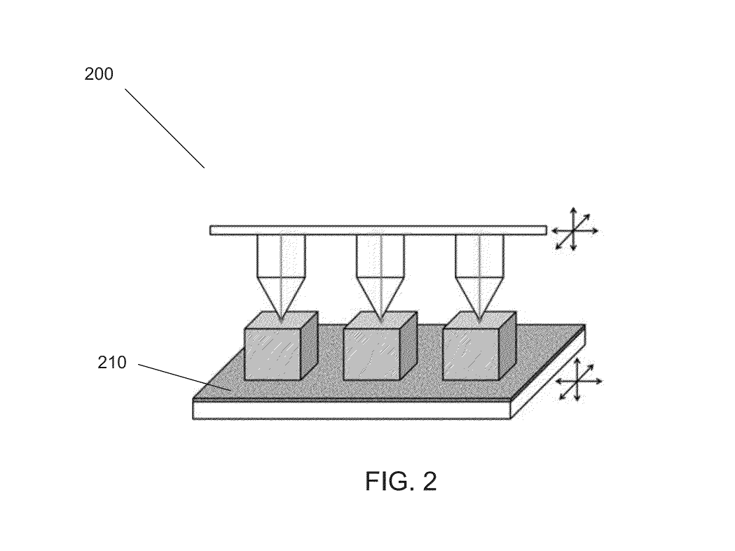

By way of background, in DMLS additive manufacturing, a bed of feedstock metallic powder is spread over a substrate, and a build head is used to heat, and thereby form, a layer of the structure to be formed; after that layer of the structure is formed, a subsequent bed of feedstock metallic powder is deposited, and a the next structural layer is formed. This process iterates until the final structure is formed. FIG. 2 illustrates a DMLS additive manufacturing apparatus that incorporates a plurality of build heads in accordance with embodiments of the invention. The additive manufacturing apparatus 200 depicted in FIG. 2 is similar to that seen in FIG. 1, except that the bed of powder 210 is depicted.

In LENS additive manufacturing, a feedstock metallic powder is provided to a build head that heats and deposits the feedstock metal into the shape of the structure to be formed. EBF³ additive manufacturing processes are similar to LENS additive manufacturing processes, except that the feedstock metal is in the form of wire, and an electron beam is typically used to heat the wire.

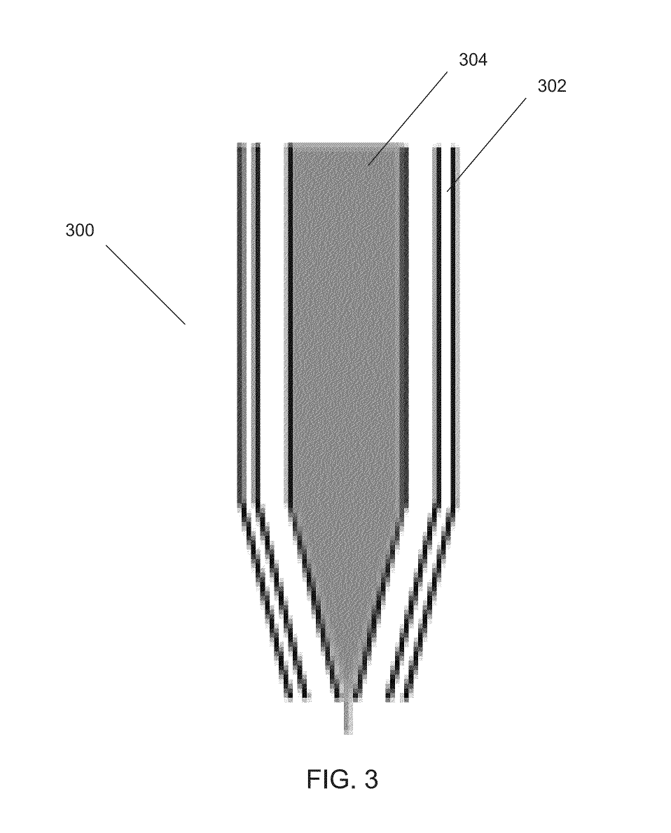

FIG. 3 illustrates a LENS/EBF³ type build head that can be implemented in additive manufacturing apparatuses in accordance with embodiments of the invention. In particular, the build head 300 includes passages for delivering a feedstock material 302, and source for heating the feedstock material 304. For example, if the build heads were adapted for implementation within a LENS-type additive manufacturing apparatus, the passages for delivering feedstock material 302 would be adapted to transfer metallic powder. Similarly, the source for heating the feedstock material 304 would be a laser, e.g. a Yg-NAG laser. Alternatively, if the build heads were adapted for implementation within a EBF³ type additive manufacturing apparatus, the passages for delivering feedstock material 302 would be adapted to transfer feedstock metal in the form of wire; similarly, the source for heating feedstock material 304 would be an electron beam.

It should be clear that the above mentioned aspects are compatible with any of a variety of additive manufacturing apparatuses in accordance with embodiments of the invention; for example, any of a variety of build heads may be implemented, not just those adapted for LENS, EBF³, or DMLS. For example, U.S. patent application Ser. No. 14/163,936 to Dough Hofmann discloses additive manufacturing processes where the build heads are adapted to deposit layers of metallic glass. Accordingly, in many embodiments of the invention, an additive manufacturing apparatus includes a plurality of build heads, at least one of which being configured to deposit layers of metallic glass and thereby additively manufacture an object. U.S. patent application Ser. No. 14/163,936 to Hofmann is hereby incorporated by reference in its entirety. Additionally, any method of heating the feedstock material so as to facilitate the additive manufacture can be implemented. For example, in some embodiments, the plurality of build heads heat feedstock material using one of: resistive heating and radio frequency heating. In general, any of a variety of different build heads can be implemented in accordance with embodiments of the invention. In some embodiments, an additive manufacturing apparatus includes at least two different types of build heads.

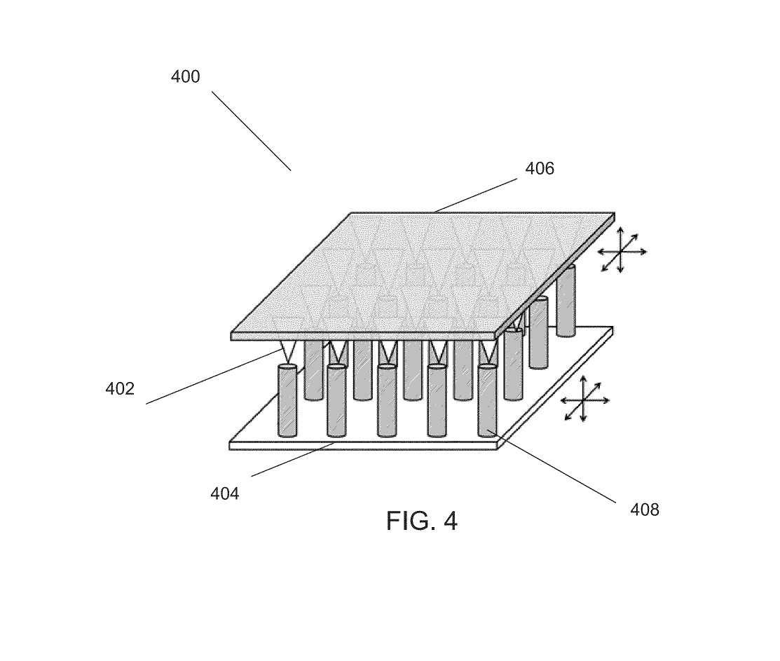

While FIG. 1 depicts an additive manufacturing apparatus with three build heads, it should be clear that additive manufacturing apparatuses can implement any number of build heads in accordance with embodiments of the invention. For example, FIG. 4 illustrates an additive manufacturing apparatus that includes an array of build heads. In particular, the additive manufacturing apparatus 400 includes a plurality of build heads 402, a substrate 404, and a translation system 406. As in FIG. 1, both the substrate 404 and the translation system 406 are depicted as being translatable. However, in some embodiments, only one of the substrate and the translation system is translatable. As can be appreciated, any scheme can be implemented that allows for the plurality of build heads to be moved relative to the substrate. Note that the illustration also depicts that each of the plurality of build heads 408 is used to fabricate a cylindrical structure 408. In some embodiments, the substrate 404 includes rotatable cylindrical platforms corresponding to the cylindrical structures. With such an arrangement, the cylindrical structures can be rotated, e.g. during the additive manufacturing process, so that the build heads can be moved relative to the structure and thereby cause the formation of further structure. In this way, structures having circular symmetry can be more easily developed. Of course, it should be understood that the partially additively manufactured structures can be spatially re-oriented in any suitable way during their additive manufacture in accordance with embodiments of the invention; the example of a rotating circular platform for each of the depicted cylindrical structures 408 is not meant to be restrictive.

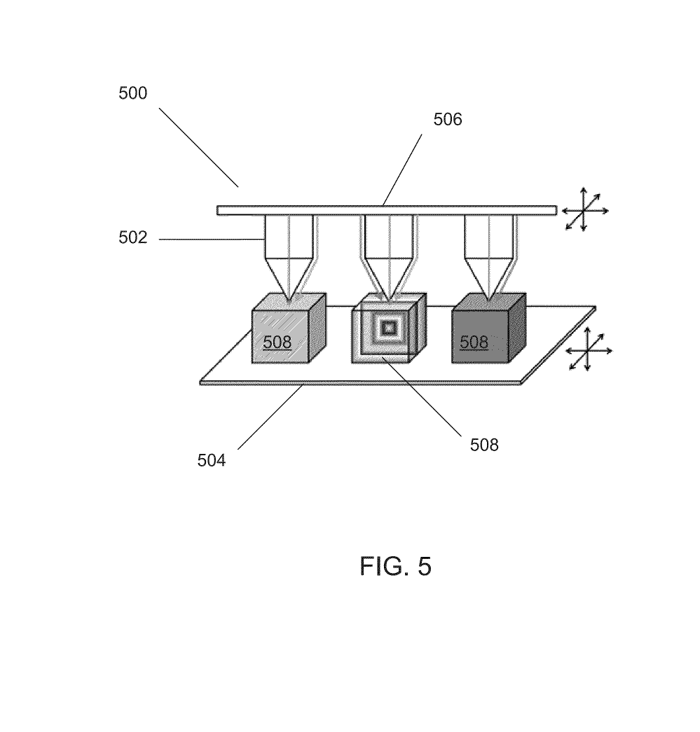

In many embodiments, at least two of a plurality of build heads incorporated within an additive manufacturing apparatus are sourced with a different feedstock material. Thus, such an apparatus can simultaneously fabricate structures having similar shapes but being made of different material. For example, FIG. 5 illustrates an additive manufacturing apparatus that includes two build heads, each being sourced with different feedstock material. In particular, the additive manufacturing apparatus 500 is depicted as having three build heads 502, a substrate 504, and a translation system 506. It is further depicted that the three build heads have been used to fabricate three identically-shaped objects 508, with each being fabricated from different constituent materials. Specifically, the left-most build head is sourced with a first feedstock material, while the right-most build head is sourced with a second, different, feedstock material. Thus, the left and right build heads are adapted to fabricate structures being constituted of different materials. The middle build head is adapted so that it can be sourced either from the first feedstock material or the second feedstock material. Accordingly, the material constitution of the corresponding structure can be highly configurable. For example, the structure developed by the middle build head can be constituted of the first feedstock material in some portions and the second feedstock material in other portions. Moreover, the build head can be sourced with some mixture of materials, where any ratio of the mixture can be implemented. In this way, the structure can be developed so that, for example, it transitions from the first feedstock material to the second feedstock material across some portion of the structure. It should of course be understood that the fabrication of one of a plurality of structures from a mixture of different feedstock materials can be achieved in any number of ways in accordance with embodiments of the invention; the above description is not intended to be restrictive.

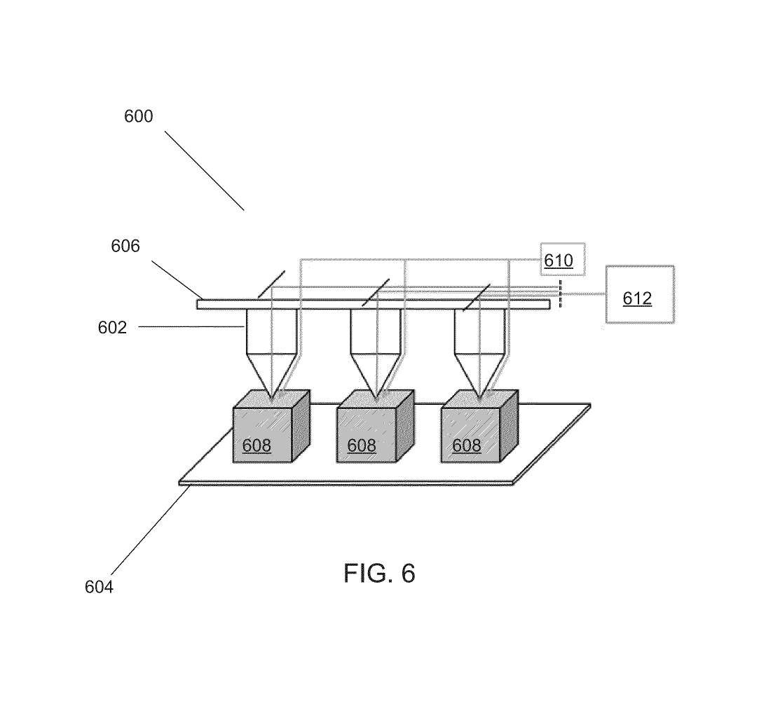

In a number of embodiments, each of the plurality of build heads is associated with a centralized power source (e.g. laser or electron beam) and/or a centralized feedstock source. In this way, the architecture for additive manufacturing apparatuses incorporating a plurality of build heads can be greatly streamlined and can allow the additive manufacturing apparatus to be more efficiently fabricated. FIG. 6 illustrates an additive manufacturing apparatus that includes a centralized power source and a centralized feedstock source. In particular, the additive manufacturing apparatus 600 includes a plurality of build heads 602, a substrate 604, a translation system 606, a centralized feedstock material source 610, and a centralized energy source 612. It is illustrated that each of the plurality of build heads 602 is sourced from the centralized feedstock material source 610. Similarly, each of the plurality of build heads 602 is powered by a centralized power source 612. For example, if the additive manufacturing apparatus is configured for a LENS type process, then the centralized power source can be a laser source. Beam splitting optics can be used to deliver the laser to each of the plurality of build heads. Note that beam splitting may reduce the power of the laser. Thus, in many embodiments, the centralized laser is of sufficient power that when it is split and provided to the plurality of build heads, it nevertheless provides adequate power to the build heads.

In many embodiments, additive manufacturing apparatuses that include a plurality of build heads that move in unison are particularly adapted for the bulk manufacture of specific parts. Whereas conventional additive manufacturing apparatuses are designed to be versatile so that they can, for example, rapid prototype any of a variety of distinct geometries, in some embodiments, additive manufacturing apparatuses are particularly configured for the additive manufacture of specific geometries. For example, in many embodiments, a translation system is configured so that it can only move in the pattern that is required for the formation of the desired geometry, e.g. so that each build head can reach the perimeter of the desired geometry, and not much further beyond that. In some embodiments, build heads are held fixed, and the substrate is translatable; this can limit the flexibility required by the cables and tubes delivering power, feedstock material or motion to the plurality of build heads. In some embodiments, the substrate is allowed to move in two dimensions, while the array of build heads can move in the third dimension. In a number of embodiments, the power source used by the build heads is only that which is compatible with the particular material being used in the fabrication of the structures. In any of these ways, additive manufacturing apparatuses can be particularly adapted for the bulk manufacture of specific parts.

While the above description has regarded additive manufacturing apparatuses implementing a plurality of build heads that are configured to move synchronously, in many embodiments, methods for efficiently additively manufacturing structures are implemented, and these processes are now described below.

### Methods for Efficiently Additively Manufacturing Structures

In many embodiments, processes for efficiently additively manufacturing structures are implemented. In a number of embodiments, methods for additively manufacturing structures include additively manufacturing structures using a plurality of build heads that are configured to move synchronously. In this way, additive manufacturing processes can be made to be more viable in the bulk manufacture of structures.

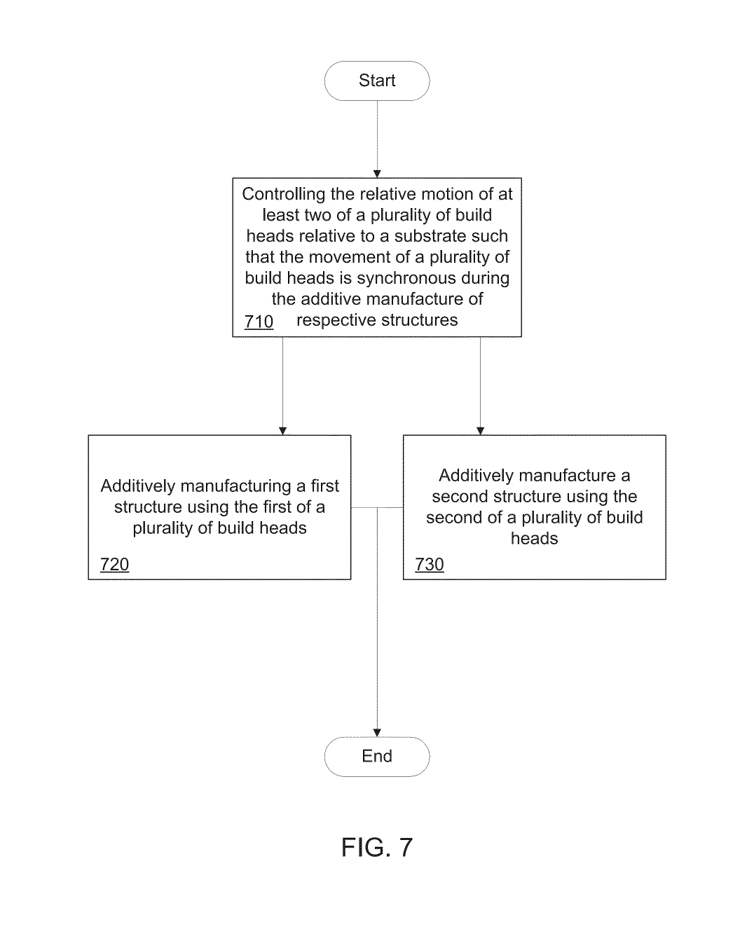

FIG. 7 illustrates a method for efficiently additively manufacturing a plurality of structures that includes controlling at least two of a plurality of build heads so that their movement is synchronous during the additive manufacture of respective structures. In particular, the method 700 includes controlling 710 the relative motion of at least two of a plurality of additive manufacturing build heads relative to a substrate such that their movement, relative to the substrate, is synchronous during the additive manufacture of respective structures. The relative motion can be controlled 710 in any suitable fashion. For example, the build heads may be coupled to a translation system that is coupled to a controller that governs its motion. In some embodiments, the substrate is coupled to a translation system, and the relative motion is thereby controlled 710.

The method 700 includes additively manufacturing 720 a first structure using the first of a plurality of build heads onto a surface, and includes the additive manufacturing 730 a second structure using the second of a plurality of build heads onto a surface. As the relative motion of the first and second of the plurality of build heads is controlled 710 such that they are synchronous, they can thereby additively manufacture similarly shaped structures. The surface that structure is additively manufactured onto can be a substrate of an additive manufacturing apparatus for example. In some embodiments, the surface is the surface of a pre-existing part. As can be appreciated, the above-described method can be implemented in conjunction with any of the above-described apparatuses in accordance with embodiments of the invention.

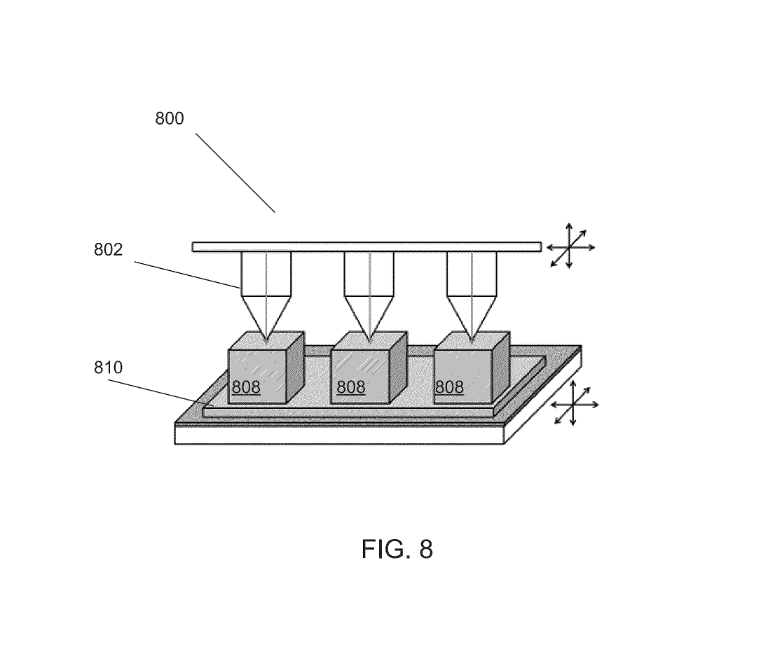

It should further be understood that the above-described method can be implemented in any of a variety of scenarios. For example, as alluded to above, a plurality of structures are additively manufactured onto a pre-existing part. For example, FIG. 8 depicts an additive manufacturing apparatus that is being used to fabricate repeating structures onto a pre-existing part. In particular, the additive manufacturing apparatus 800 depicted is similar to that seen in FIG. 1, in that it includes a plurality of build heads 802 that are configured to move synchronously (in relation to a substrate) during the additive manufacture of structures. The illustration depicts that a plurality of structures 808 are additively manufactured onto a single preexisting part 810. In essence, with this technique, repeating features can be efficiently implemented onto a pre-existing structure in accordance with embodiments of the invention.

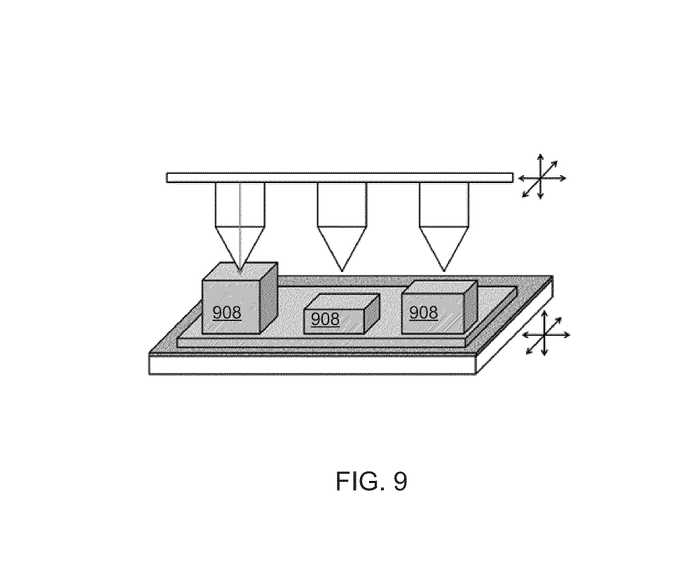

In many embodiments, methods for efficiently fabricating non-identical structures are implemented. For example, in many embodiments, a plurality of build heads is controlled such that each build head traverses a similar path, but the build heads do not necessarily cause the formation of structure at the same time as one another. FIG. 9 depicts that an additive manufacturing apparatus is used in the fabrication of similar but non-identical structures in accordance with embodiments of the invention. In particular, the illustration is similar to that seen in FIG. 8 except that the plurality of structures 908 fabricated on to the pre-existing structure are non-identical. Specifically, the middle build head produced a structure that is shorter than that of the either of the other build heads. This can be achieved, for example, by controlling the ability of the middle build head to precipitate the formation of structure. Hence, while all of the build heads may be moving synchronously, the middle build head can be controlled to not cause the formation of structure part way through the additive manufacturing process. In this way, non-identical structures can be efficiently additively manufactured. As can be appreciated, the ability to control whether or not a build head is causing the development of structure can allow for great flexibility in the efficient development of a plurality of structures. Of course, it should be appreciated, that each of the plurality of build heads can be controlled in any suitable manner in accordance with embodiments of the invention.

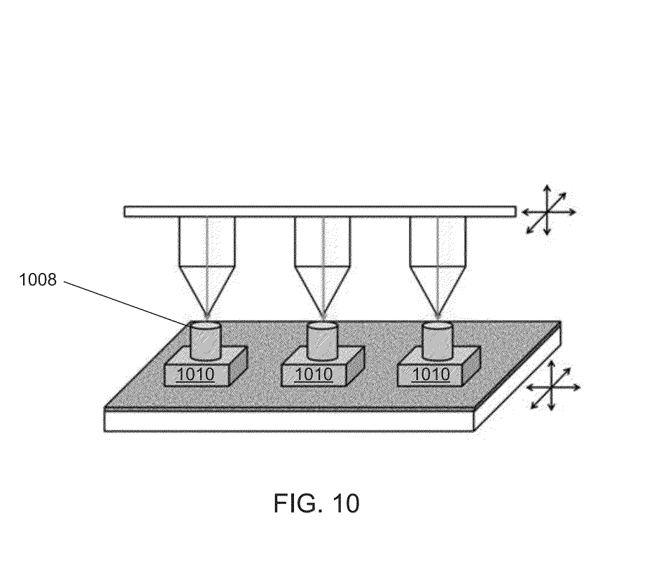

While FIGS. 8 and 9 depict the fabrication of a plurality of structures onto a singular pre-existing part, in many embodiments, a plurality of structures are fabricated onto a corresponding preexisting plurality of objects. FIG. 10 illustrates such an example. In particular, FIG. 10 is similar to that seen previously in FIG. 1, except that a plurality of cylindrical structures 1008 is depicted as having been additively manufactured onto a plurality of preexisting rectangular blocks 1010. Using these techniques, additive manufacturing processes can be harnessed where they offer the most viable manufacturing solution. For example, it may be efficient to fabricate part of a structure using conventional manufacturing techniques, and the remainder of the structure using additive manufacturing techniques. It should of course be understood that the ability to additively manufacture structures onto preexisting structures can be taken advantage of in any number of ways in accordance with embodiments of the invention, not just those listed above.

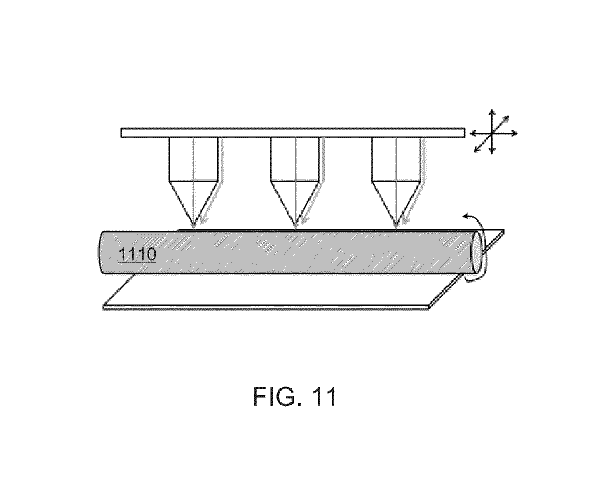

In many embodiments, a preexisting part upon which structures are being additively manufactured can be spatially re-oriented during the additive manufacturing process. For example, the pre-existing structure can be rotated such that the developed structure can be developed so as to be symmetrical. FIG. 11 illustrates rotating a work piece during additive manufacturing in accordance with embodiments of the invention. In particular, FIG. 11 depicts an additive manufacturing apparatus, as seen previously, e.g. with respect to FIG. 1; the additive manufacturing apparatus is depicted as developing structure onto a rotating cylindrical work piece 1110. In this fashion, structure can be developed onto the work piece 1110, such that, for example, the added structure can be made to be symmetrical about the central axis of the cylindrical work piece. Of course, it should be understood that a work piece upon which a plurality of structures are being additively manufactured on can be spatially re-oriented in any of a variety of ways in accordance with embodiments of the invention, e.g. not just rolled about its central axis. Moreover, in many embodiments, the additively manufactured structure itself (i.e. not the work piece upon which structure is developed) is spatially re-oriented during the additive manufacturing processes. This flexibility can, for example, allow intricate features to be more easily developed.

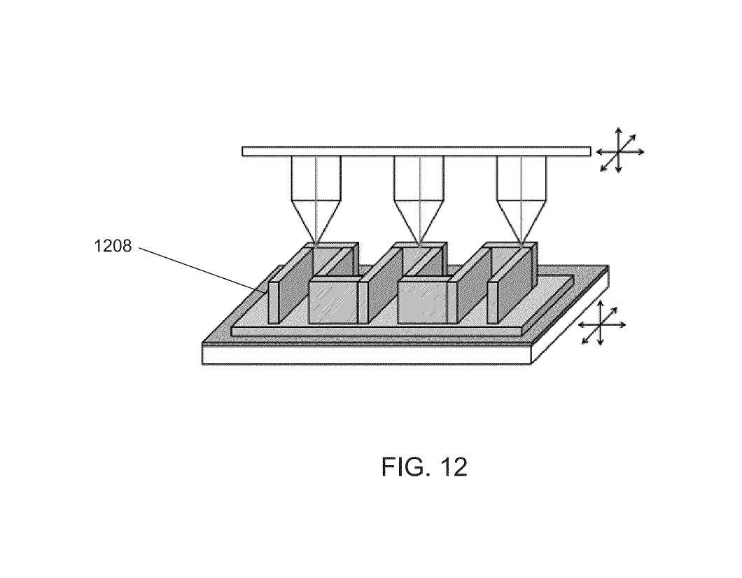

In many embodiments, a plurality of structures is fabricated such that each structure is adjoined to an adjacent structure and thereby constitute cells within a single cellular structure. For example, FIG. 12 depicts how a singular cellular structure can be efficiently additively manufactured in accordance with embodiments of the invention. In particular, an additive manufacturing apparatus similar to that seen with respect to FIG. 1 is depicted. Each of the plurality of build heads is shown additively manufacturing a structure 1208 that is adjoined to an adjacent identical structure. Accordingly, each of the additively manufactured structures can be understood to be a cell within the single cellular structure that is to be formed. As can be appreciated, a cellular structure comprising any number of cells can be efficiently additively manufactured using a corresponding number of build heads in accordance with embodiments of the invention. Of course, cellular structures having constituent cells of any shape can be fabricated in accordance with embodiments of the invention.

While the above description has largely regarded additive manufacturing processes that implement a plurality of build heads that synchronously traverse an identical path in relation to a substrate while additively manufacturing structures, in many embodiments, additive manufacturing apparatuses include a plurality of build heads that are independently operable and are used in conjunction with one another in the additive manufacture of a structure. This is now discussed in greater detail below.

Additive Manufacturing Apparatuses that Include a Plurality of Build Heads, Each of which Being Independently Operable

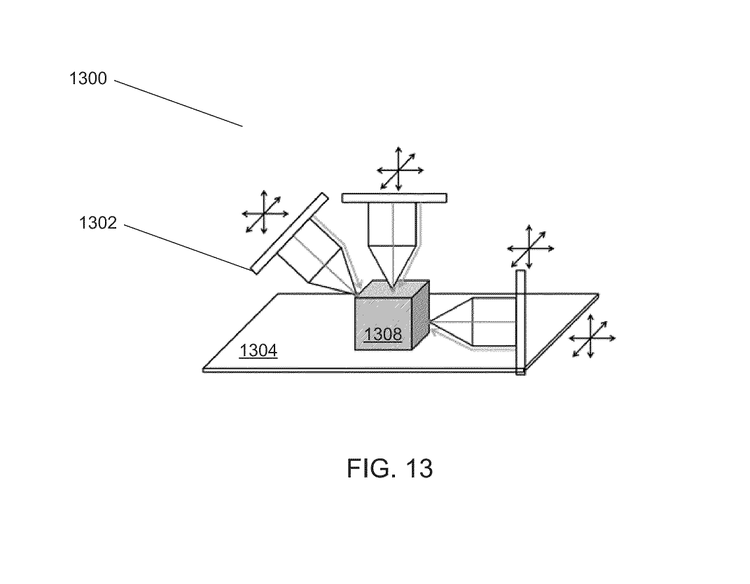

In many embodiments, additive manufacturing apparatuses include a plurality of independently operable build heads. In this way, different aspects of a structure to be fabricated can be simultaneously additively manufactured. FIG. 13 illustrates an additive manufacturing apparatus that includes three independently operable build heads in accordance with embodiments of the invention. In particular, additive manufacturing apparatus 1300 includes three independently operable build heads 1302, and a substrate 1304. The apparatus is depicted as additively manufacturing a structure 1308. As is depicted in the illustration, the three independently operable build heads 1302 and the substrate can all be moved relative to one another. Note that the build heads 1302 can be spatially oriented in any suitable matter; their movement is not limited to translation. Thus, each of the three build heads 1302 is depicted as having a different spatial orientation. Each of the three build heads can be controlled in any suitable fashion to contribute to the additive manufacture of a structure. Thus, for example, each of the plurality of build heads can be controlled to develop a particular aspect of the structure to be fabricated. In this way, a desired structure may be more rapidly developed. Of course, it should be understood that although an additive manufacturing apparatus having three independently operable build heads is illustrated, additive manufacturing apparatuses having any number of build heads can be implemented in accordance with embodiments of the invention. Moreover, each of the independently operable build heads can be used in any suitable fashion in accordance with embodiments of the invention. For example, two subsets of the plurality of independently operable build heads can be used to fabricate distinct respective structures.

As can be inferred from the above discussion, the above-mentioned concepts can be implemented in a variety of arrangements in accordance with embodiments of the invention. Generally, additive manufacturing apparatuses that incorporate a plurality of build heads can be used in a variety of ways in accordance with embodiments of the invention. Accordingly, although the present invention has been described in certain specific aspects, many additional modifications and variations would be apparent to those skilled in the art. It is therefore to be understood that the present invention may be practiced otherwise than specifically described. Thus, embodiments of the present invention should be considered in all respects as illustrative and not restrictive.

What claimed is:

1. An additive manufacturing apparatus comprising:
a plurality of build heads, each of which being adapted to cause the formation of
a structure onto a surface;
a substrate; and
a translation system, wherein the translation system is associated with at least one of the plurality of build heads and the substrate, such that the spatial relationship between the plurality of build heads and the substrate can be controlled.

2. The additive manufacturing apparatus of claim 1 further comprising a controller for controlling the spatial relationship between the plurality of build heads and the substrate.

3. The additive manufacturing apparatus of claim 2, wherein the plurality of build heads is configured for functionality in accordance with a direct metal laser sintering additive manufacturing apparatus.

4. The additive manufacturing apparatus of claim 2, wherein at least one of the plurality of build heads is one of: a build head configured for functionality in accordance with a laser engineered net shaping additive manufacturing process and a build head configured for functionality in accordance with an electron beam freeform fabrication additive manufacturing process.

5. The additive manufacturing apparatus of claim 2, wherein at least one of the plurality of build heads receives metallic feedstock in the form of one of: powder and wire.

6. The additive manufacturing apparatus of claim 2, wherein at least one of the plurality of build heads heats feedstock using one of: a laser and an electron beam.

7. The additive manufacturing apparatus of claim 2, wherein at least two of the plurality of the build heads are each sourced with a different feedstock material.

8. The additive manufacturing apparatus of claim 2, wherein at least one build head is sourced with a combination of two different feedstock materials.

9. The additive manufacturing apparatus of claim 2, wherein at least two of the plurality of build heads are sourced with feedstock material from a centralized feedstock material source.

10. The additive manufacturing apparatus of claim 2, wherein at least two of the plurality of build heads are powered by a single power source.

11. The additive manufacturing apparatus of claim 10, wherein the power source is laser, and wherein the laser is communicated to each of the at least two of the plurality of build heads using at least one of: beam splitters and optics.

12. A method of additively manufacturing a plurality of structures comprising:
additively manufacturing a first structure using the first of a plurality of build heads;
additively manufacturing a second structure using the second of the plurality of build heads;
wherein at least the first of the plurality of build heads and the second of the plurality of build heads are controlled so as to move in unison relative to a substrate during the additive manufacturing of the respective structures.

13. The method of claim 12, wherein at least the first structure and the second structure are additively manufactured onto a surface that is removably disposed onto the substrate.

14. The method of claim 12 wherein there is at least one moment in time where either the first of the plurality of build heads is causing the formation of structure when the second of the plurality of build heads is not causing the formation of structure or the second of the plurality of build heads is causing the formation of structure when the first of the plurality of build heads is not causing the formation of structure.

15. The method of claim 12, wherein the additive manufacturing of the first structure occurs on a first surface, and the additive manufacturing of the second structure occurs on a second distinct surface, wherein each of the first surface and the second surface are removably disposed on the substrate.

16. The method of claim 12, wherein the additive manufacturing of the first structure and the second structure occur on a rotating surface.

17. The method of claim 12, wherein the first structure and the second structure are additively manufactured so that they are identical in shape and are adjoined.

18. The method of claim 12, wherein the first structure is additively manufactured from a first material, and the second structure is additively manufactured from a second, different, material.

19. The method of claim 12, wherein at least the first structure is additively manufactured from a combination of materials.

20. An additive manufacturing apparatus comprising:
a plurality of build heads, each of which being adapted to cause the formation of
a structure onto a surface; and
a substrate;
wherein each of the plurality of build heads is configured to be able to operate independently from each of the other build heads.
